(19) United States
(12) Patent Application Publication
(10) Pub. No.: US 2010/0165071 A1
(43) Pub. Date: Jul. 1, 2010

(54) VIDEO CONFERENCE DEVICE

(75) Inventors: Toshiaki Ishibashi, Fukuroi-shi (JP); Ryo Tanaka, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA COPORATION, Hamamatsu-shi, Shizuoka (JP)

(21) Appl. No.: 12/600,400

(22) PCT Filed: May 1, 2008
(86) PCT No.: PCT/JP2008/058390

§ 371 Date: Nov. 16, 2009

(30) Foreign Application Priority Data
May 16, 2007 (JP) 2007-130589

(51) Int. Cl. H04N 7/15

(52) U.S. Cl. 348/14.08; 348/E07.083

(57) ABSTRACT

A video conference device capable of suppressing a processing burden of an echo canceller in such a situation that speakers, microphones, and a camera are arranged in close vicinity of a monitor is provided. A preliminary filter portion 18 is provided in a preceding stage of an echo canceller 19. The preliminary filter portion 18 has an LPF 181, a fixed filter 182, and a post processor 183. A controlling portion 14 sets a filter coefficient corresponding to a sound collecting beam signal that a signal selecting portion 17 selected, in the fixed filter 182. This filter coefficient is set to simulate a transfer function of an acoustic transfer system that feedbacks from the speakers to the microphones. A component of a low frequency band (e.g., 1 kHz or less) out of sound signals (input sound signals) being input into the speakers is input into the fixed filter 182, and a pseudo signal is produced. The pseudo signal (feedback component) is removed by the post processor 183, and a corrected sound collecting beam signal MSs is produced.

### TECHNICAL FIELD

The present invention relates to a video conference device in which speakers, microphones, and a camera are arranged in close vicinity of a monitor.

### BACKGROUND ART

In recent years, the communication conference device that holds a communication conference at remote places comes into widespread use. The communication conference device transmits the sound picked up by the microphone to the destination side and receives the sound from the destination side. Also, recently the video conference device that transmits/receives video data is now widespread (see Patent Literature 1, for example). In the device in Patent Literature 1, the picked-up image of the whole conference room and the picked-up image of the talker in a zoom-in mode can be switched and transmitted.

In the video conference, it is natural that each conferee talks while looking at the monitor on which the video of the destination side is shown. Therefore, it is common that the speakers, the microphones, and the camera are arranged near the monitor.

### Patent Literature 1: JP-A-2-202275

### DISCLOSURE OF THE INVENTION

### Problems that the Invention is to Solve

However, in the device in Patent Literature 1, the microphone is provided to the position of each talker to specify the talker's position. In this case, the microphone of the same number as the talkers must be provided, and this device needs a high cost and lacks the versatility.

Meanwhile, it may be considered that the directional microphone is provided near the monitor. In this case, the speaker and the microphone are arranged closely mutually, so that the feedback sound becomes large and thus the processing burden of the echo canceller is increased.

It is an object of the present invention to provide a video conference device capable of suppressing a processing burden of an echo canceller in such a situation that speakers, microphones, and a camera are arranged in close vicinity of a monitor.

### Means for Solving the Problems

A video conference device of the present invention, includes an image picking-up portion which picks up an image; a sound emitting portion which emits a sound; a sound collecting portion which collects a sound; a sound collection signal processing portion which applies a signal processing to a sound signal that is collected by the sound collecting portion to output a sound collecting signal; an input signal processing portion which applies a signal processing to an input signal that is input from an outside, and inputs the input signal that is subjected to the signal processing to the sound emitting portion; a fixed filter which applies a filtering to the input signal based on a filter coefficient; a filter coefficient setting portion which sets a pseudo filter coefficient that simulates a transfer function of an acoustic transfer system which is extended from the sound emitting portion to the sound collecting portion, as the filter coefficient of the fixed filter; a post processor which produces a corrected sound collecting signal by subtracting an output signal of the fixed filter from the sound collecting signal; and an adaptive echo canceller which subtracts a pseudo echo signal, which is obtained by processing the input signal by an adaptive filter, from the corrected sound collecting signal produced by the post processor.

In this configuration, a preliminary filter portion (the fixed filter, the post processor) for removing the feedback component in the predetermined frequency band is provided in the preceding stage of the adaptive echo canceller. The filter coefficient is set in advance under the assumption that the transfer function of the acoustic transfer system extending from the sound emitting portion to the sound collecting portion is assumed. Since the feedback component that is hard to accept the influence of a change in the sound collecting directivity is removed in the preceding stage of the adaptive echo canceller, the processing burden of the adaptive echo canceller can be suppressed even in such a situation that the speakers, the microphones, and the camera are arranged in close vicinity of the monitor. In particular, the remarkable advantage can be achieved in the low-frequency band.

Preferably, the image picking-up portion, the sound emitting portion, and the sound collecting portion are arranged in close vicinity to each other.

Preferably, the sound emitting portion and the sound collecting portion are formed integrally with a main body of the video conference device.

Preferably, the image picking-up portion is formed integrally with the main body of the video conference device.

Preferably, the sound collecting portion has a microphone array in which a plurality of microphones are aligned. The sound collection signal processing portion includes: a sound-collection beam producing portion for producing a plurality of sound collecting beam signals having a sound collecting directivity in a plurality of directions, by applying a delay processing to the sound signal picked up by the plurality of microphones and synthesizing delayed sound signals; and a signal selecting portion for sensing a talker's direction based on levels of sound volumes of the plurality of sound collecting beam signals, and outputting a sound collecting beam signal in the talker's direction as the sound collecting signal. The filter coefficient setting portion sets the filter coefficient, which corresponds to the sound collecting beam signal that the signal selecting portion selects, out of a plurality of filter coefficients which correspond to the sound collecting directivities of the plurality of sound collecting beam signals produced by the sound-collection beam producing portion to the fixed filter, as the pseudo filter coefficient.

In this configuration, the sound collecting portion is configured by the microphone array in which a plurality of microphones are aligned. A plurality of sound collecting beam signals having a sharp directivity in a predetermined direction respectively are formed by delaying the sound signals picked up by the microphones and synthesizing these sound signals. The sound collecting beam signal whose level is highest is selected as the talker's direction, by comparing the levels of the plurality of sound collecting beam signals. The filter coefficient setting portion stores a plurality of filter coefficients corresponding to respective sound collecting beam signals, and changes the pseudo filter coefficient in real time.

Preferably, the video conference device further includes a band-pass filter provided at a preceding stage of the fixed filter to allow only a predetermined frequency band of the input signal to pass through.

In this configuration, the band-pass filter is further provided as the preliminary filter. Accordingly, the feedback signal in the predetermined frequency band is removed in the preceding stage of the echo canceller.

Preferably, the band-pass filter is a low-pass filter whose pass band is below 1 kHz.

In this configuration, a pass band of the band-pass filter is set to 1 kHz or less, and only the feedback component in the low-frequency band is removed by the fixed filter and the post processor. In the high frequency band (1 kHz or more), a detouring level is different largely depending on the direction of the sound collecting directivity, so that only the low-frequency band is removed.

Preferably, the image picking-up portion changes a shooting condition based on the talker's direction sensed by the signal selecting portion.

Preferably, the signal selecting portion further includes a band pass filter that allows a main component band of a human voice to pass through, and senses the talker's direction based on the signal levels of the plurality of sound collecting beam signals subjected to a band-pass filtering process by the band pass filter.

### ADVANTAGES OF THE INVENTION

According to this invention, the filter for eliminating preliminarily the feedback component that is hardly influenced by a change in the sound collecting directivity is provided. Therefore, the processing burden of the adaptive echo canceller can be suppressed even in the condition that the speakers, the microphones, and the camera are arranged in close vicinity of the monitor.

### BRIEF DESCRIPTION OF THE DRAWINGS

FIG. 1 An external view of a video conference device.

FIG. 2 A block diagram showing a configuration of the video conference device.

FIG. 3 A view showing a sound collection beam area formed by the video conference device.

FIG. 4 A block diagram showing a configuration of a signal selecting portion 17 shown in FIG. 2.

FIG. 5 A view showing a level of a feedback signal.

### DESCRIPTION OF REFERENCE NUMERALS AND SIGNS

11 camera
SP1 to SP8 speaker
M1 to M12 microphone

### BEST MODE FOR CARRYING OUT THE INVENTION

A video conference device according to an embodiment of the present invention will be explained with reference to the drawings hereinafter.

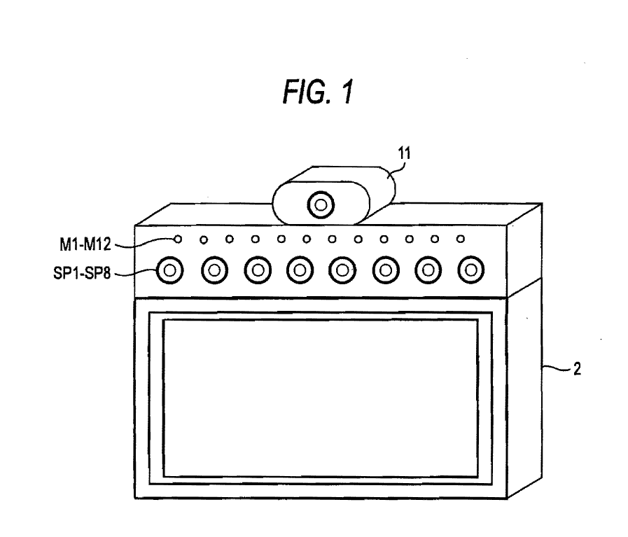

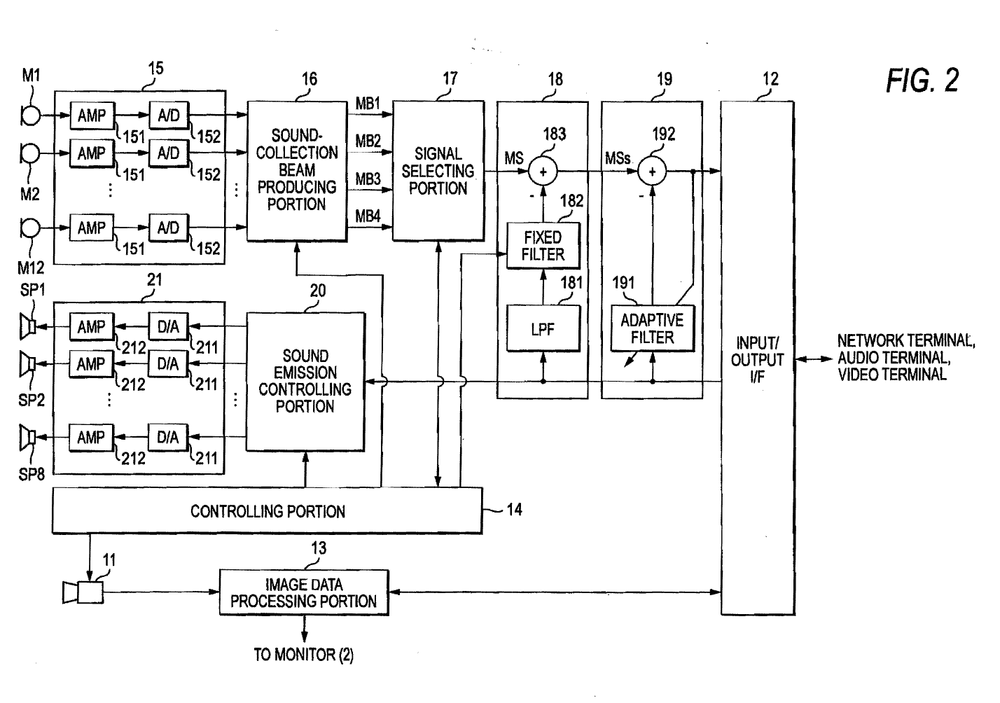

FIG. 1 is an external view of a video conference device, and FIG. 2 is a block diagram showing a configuration of the video conference device. The video conference device includes speakers SP1 to SP8, microphones M1 to M12, and a camera 11, and these elements are arranged in close vicinity and provided on a monitor 2 as an integrated case.

The speakers SP1 to SP8 are aligned linearly to constitute a speaker array. The microphones M1 to M12 are aligned linearly to constitute a microphone array. In this case, in the present embodiment, an example in which the number of speakers is set to 8 and the number of microphones is set to 12 is illustrated, but respective aligned numbers are not limited to this example. Also, the aligned intervals of the speakers and the microphones are not limited to an equal interval.

As shown in FIG. 2, the video conference device includes an input/output I/F 12, an image data processing portion 13, a controlling portion 14, an ND converting portion 15, a sound-collection beam producing portion 16, a signal selecting portion 17, a preliminary filter portion 18, an echo canceller 19, a sound-emission controlling portion 20, and a D/A converting portion 21, in addition to the speakers SP1 to SP8, the microphones M1 to M12, and the camera 11.

The controlling portion 14 is connected to the camera 11, the sound-collection beam producing portion 16, the signal selecting portion 17, the preliminary filter portion 18, and the sound-emission controlling portion 20, and controls in coordination the video conference device. For example, the controlling portion 14 sets a shooting range of the camera 11, controls a sound collection level and a sound emission level, and the like in response to the user's operation input from a remote controller (not shown). Also, the controlling portion 14 sets a filter coefficient of a fixed filter 182 of the preliminary filter portion 18. A memory for recording a plurality of filter coefficients of the fixed filter 182 is built in the controlling portion 14.

The input/output I/F 12 is connected to the network terminal, the audio terminal, and the video terminal. The input/output I/F 12 transmits/receives the sound and the video to/from the destination video conference device via these terminals. When the transmission/reception are executed via the network terminal, the input/output I/F 12 transmits/receives respective data the sound and the video in the data format for the network communication. The received video data are output to image data processing portion 13. The received sound data are converted into digital sound signals, and are output to the echo canceller 19, the preliminary filter portion 18, and the sound-emission controlling portion 20.

Also, the input/output I/F 12 transmits the video data being input from the image data processing portion 13 to the destination video conference device in the data format for the network communication. Also, the input/output I/F 12 transmits the digital sound signals being input from the echo canceller 19 to the destination video conference device in the data format for the network communication.

The camera 11 picks up the image in a range in which the conferee being sit in front of own device, and outputs the video signal to the image data processing portion 13. When the camera 11 is equipped with panning, tilting, zooming functions, the shooting range is set by the controlling portion 14. In addition, shooting conditions, etc. (contrast, etc.) are set by the controlling portion 14.

The image data processing portion 13 converts the video signal being input from the camera 11 into the video data (compressed data), and outputs this video signal to the input/output I/F 12. Also, the image data processing portion 13 decodes the video data being input from the input/output I/F 12, and outputs the video data to the monitor 2 as the video signal.

The microphones M1 to M12 of the microphone array collect the emitted sounds of the conferees (talkers) positioned in front of their own units, and produces the sound-collecting sound signals.

The A/D converting portion 15 has a sound collecting amplifier 151 and an A/D converter 152 so as to correspond to the microphones M1 to M12 respectively. The sound collecting amplifier 151 amplifies the sound-collecting sound signals. The ND converter 152 converts the amplified sound-collecting sound signals into the digital sound signal, and outputs the sound signals to the sound-collection beam producing portion 16.

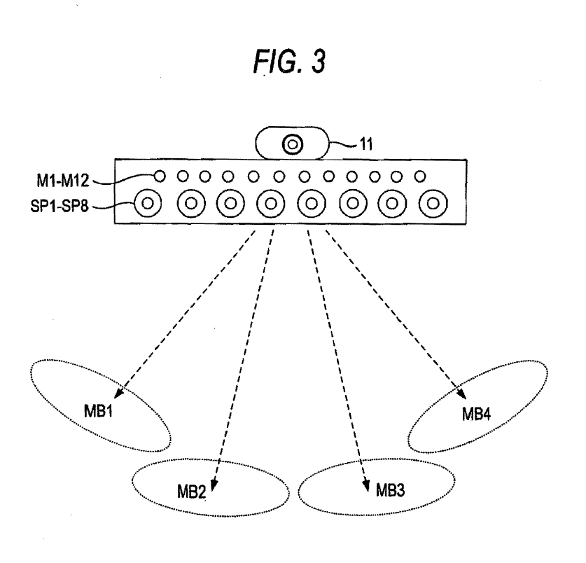

The sound-collection beam producing portion 16 conducts a predetermined delay process to respective digital sound signals being input from the ND converting portion 15, and then synthesizes respective delayed signals. Thus, the sound-collection beam producing portion 16 produces sound-collection beam signals MB1 to MB4 as the beam signals in which the sounds arriving at from the particular area are emphasized. As shown in FIG. 3, in the sound-collection beam signals MB1 to MB4, areas whose predetermined width is different along the long surface side, on which the microphones M1 to M12 are provided, respectively are set as sound collecting beam areas (the particular space and direction being emphasized by the sound-collection beam signals). In this case, the number of sound collecting beams and the positions of the areas are not limited to this example. The controlling portion 14 can change the sound collecting beam areas by controlling an amount of delay of each digital sound signal respectively.

The signal selecting portion 17 selects the signal whose level is highest out of the sound-collection beam signals MB1 to MB4, and outputs the sound-collection beam signal to the preliminary filter portion 18 as a main sound-collecting beam signal MS. Also, the signal selecting portion 17 informs the controlling portion 14 of the selected sound-collecting beam signal.

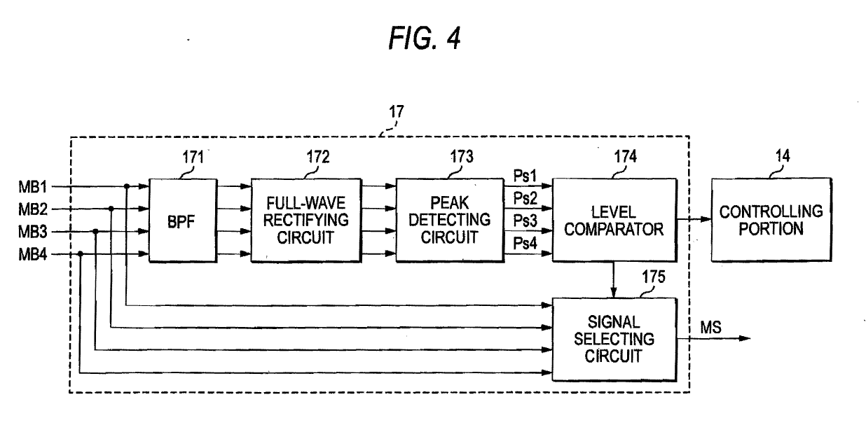

FIG. 4 is a block diagram showing a main configuration of the signal selecting portion 17.

The signal selecting portion 17 has a BPF (band-pass filter) 171, a full-wave rectifying circuit 172, a peak detecting circuit 173, a level comparator 174, and a signal selecting circuit 175.

The BPF 171 is a band-pass filter whose pass band corresponds to a major component band of the human voice. The BPF 171 applies a band-pass filtering process to the sound-collection beam signals MB1 to MB4, and outputs the processed beam signal to the full-wave rectifying circuit 172. The full-wave rectifying circuit 172 applies the full-wave rectification to the sound-collection beam signals MB1 to MB4 (absolute values). The peak detecting circuit 173 detects peaks of the full-wave rectified sound-collection beam signals MB1 to MB4 respectively, and outputs peak value data Ps1 to Ps4. The level comparator 174 compares the peak value data Ps1 to Ps4, and gives the selection commanding data indicating that the sound-collection beam signal corresponding to the peak value data whose level is highest should be selected, to the signal selecting circuit 175. Also, the level comparator 174 gives the selection commanding data indicating that the sound-collection beam signal corresponding to the peak value data whose level is highest should be selected, to the controlling portion 14. The signal selecting circuit 175 selects the sound-collection beam signal indicated by the selection commanding data, and outputs this sound-collection beam signal to the preliminary filter portion 18 as the main sound-collecting beam signal MS.

This selection is made based upon the fact that a signal level of the sound-collection beam signal corresponding to the sound-collecting area where the taker exists is higher than signal levels of the sound-collection beam signals corresponding to other areas.

The controlling portion 14 changes the shooting conditions of the camera 11 based on the selection commanding data being input from the level comparator 174. For example, the controlling portion 14 set the pan, the tilt, the zoom of the camera 11 to pick up the image of the area that corresponds to the selected sound-collecting beam signal. Also, the controlling portion 14 sets the filter coefficient of the fixed filter 182 in the preliminary filter portion 18 based on the selection commanding data.

The preliminary filter portion 18 has a LPF (low-pass filter) 181, the fixed filter 182, and a post processor 183. The LPF 181 is a low-pass filter whose pass band is a low-frequency band (e.g., 1 kHz or less). The LPF 181 applies a low-pass filtering process to the signal being input from the echo canceller 19, i.e., the input sound signal being input from other unit, and outputs the processed signal to the fixed filter 182.

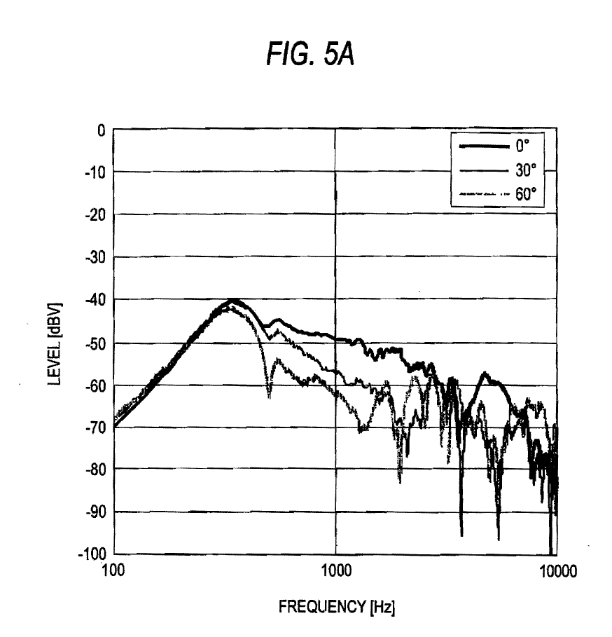

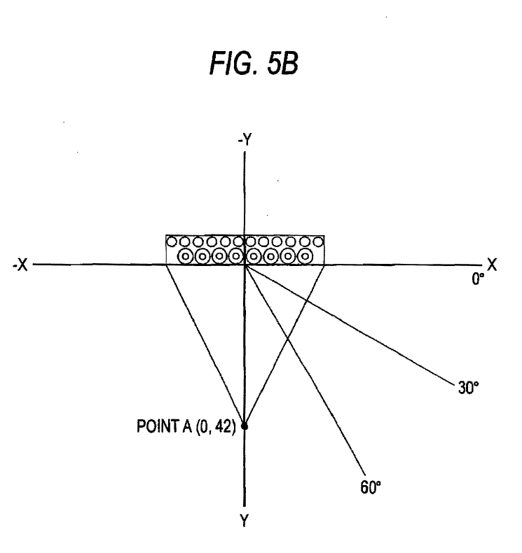

The fixed filter 182 is a FIR filter, and its filter coefficient is set by the controlling portion 14. The controlling portion 14 sets the filter coefficients that simulate the echo transmitting paths from the speakers (SP1 to SP8) to the microphones (M1 to M12). Details of the filter coefficients will be described by using FIG. 5. The fixed filter 182 applies the filtering to the input sound signals that are subjected to a band limitation by the LPF 181, and produces the pseudo signal that simulates the feedback signal reaching from the speakers to the microphones. In this case, the function of the LPF 181 may be implemented in the fixed filter 182.

The preliminary filter portion 18 subtracts this pseudo signal from the main sound-collecting beam signal MS by the post processor 183. Thus, the preliminary filter portion 18 produces a corrected sound-collecting beam signal MSs from which the feedback component in the low-frequency band is removed.

The echo canceller 19 has an adaptive filter 191 and a post processor 192. The adaptive filter 191 produces the pseudo feedback sound signal that simulates the feedback sound signal that feedbacks from the speaker array to the microphone array, based on the input sound signal. The post processor 192 subtracts the pseudo feedback sound signal from the corrected sound-collecting beam signal MSs being output from the preliminary filter portion 18, and outputs a resultant signal to the input/output I/F 12 as an output sound signal. Accordingly, the echo component is eliminated. Also, the output sound signal is input into the adaptive filter 191, and then the adaptive filter 191 updates the filter coefficient based on the input output sound signal to eliminate the echo component.

The sound emission controlling portion 20 applies a predetermined delay process to the input sound signal, and then inputs the delayed signal into respective D/A converters 211 in the D/A converting portion 21. The D/A converters 211 convert the input sound signals into the analog sound signals, and input the analog sound signals to AMPs 212. The AMPs 212 amplify the analog sound signals and input them into the speakers SP1 to SP8, and then the speakers SP1 to SP8 emit the sound.

The sound emission controlling portion 20 can form the sound emitting beams that have a sharp directivity in a predetermined direction, by applying the delay process to the sound signals that are to be input into respective speakers of the speaker array respectively. Also, the sound emission controlling portion 20 can form the sound emitting beam such that the sound emitting beams form the focus in a predetermined position. Although actual distances between respective speakers and the focal point are different respectively, the sound signals may be delayed such that the sounds are emitted at timings given when these speakers are aligned at an equal distance from the focal point respectively.

Next, FIGS. 5A and 5B are views showing a level of the feedback signal. In a graph shown in FIG. 5A, an abscissa denotes a frequency and an ordinate denotes a level. FIG. 5A shows sound collecting levels of the microphone array (level of the main sound collecting beam signal) when the sound emitting beam that places the focus in the predetermined front position (white noise) is output by using the speaker array in the video conference device. FIG. 5B shows the sound collecting direction and the focal position of the emitted sound of the video conference device when the video conference device is viewed from the top surface side. In FIG. 5B, a center position of the video conference device is assumed as an origin, the rightward direction of a sheet is assumed as an X direction, the leftward direction is assumed as a −X direction, the upward direction is assumed as a −Y direction, and the downward direction is assumed as a Y direction. Also, the X-axis is set to 0°, and the Y-axis is set to 90°.

The sound emitted from the speaker array (white noise) focuses on a point A (0,42). This point A (0,42) denotes a point that is distant by 42 cm from the center position of the video conference device in the Y direction. FIG. 5A shows the sound collecting signal levels when the sound collecting beam is directed in the direction of 0°, 30° and 60° respectively while the sound emitting beam that focuses on this point A is output. As shown in FIG. 5A, the feedback level reaches maximum near 300 to 400 Hz at all angles. Also, the frequency characteristics are different largely in the band of 1 kHz or more depending on the angle. Therefore, in the preliminary filter portion 18, the frequency of 1 kHz or more is cut by the LPF 181, and the filter coefficient is set only to the band of less than 1 kHz by the fixed filter 182.

The controlling portion 14 records the filter coefficients in every angle of the sound collection beam. That is, the controlling portion 14 records the filter coefficients corresponding to the sound collecting angles in every sound collecting beam signals MB1 to MB4 respectively. Like the frequency characteristics shown in FIG. 5A, the filter coefficient has the characteristic that simulates the feedback sound.

The controlling portion 14 sets the filter coefficient corresponding to the selected sound collecting beam signal in the fixed filter 182, based on the selection commanding data being input from the level comparator 174 of the signal selecting portion 17. Accordingly, the corrected sound-collecting beam signal MSs gives the signal in which the feedback component in the low-frequency band (below 1 kHz) is reduced from the main sound-collecting beam signal MS. As a result, the feedback component becomes relatively small in the echo canceller 19, and the processing burden is reduced.

Also, the controlling portion 14 may set a previously decided single filter coefficient in the fixed filter 182. For example, the filter coefficient corresponding to the frequency characteristic when the sound collecting beam is set in the direction of 30° may be set in the graph shown in FIG. 5A.

1. A video conference device, comprising:
an image picking-up portion which picks up an image;
a sound emitting portion which emits a sound;
a sound collecting portion which collects a sound;
a sound collection signal processing portion which applies a signal processing to a sound signal that is collected by the sound collecting portion to output a sound collecting signal;
an input signal processing portion which applies a signal processing to an input signal that is input from an outside, and inputs the input signal that is subjected to the signal processing to the sound emitting portion;
a fixed filter which applies a filtering to the input signal based on a filter coefficient;
a filter coefficient setting portion which sets a pseudo filter coefficient that simulates a transfer function of an acoustic transfer system which is extended from the sound emitting portion to the sound collecting portion, as the filter coefficient of the fixed filter;
a post processor which produces a corrected sound collecting signal by subtracting an output signal of the fixed filter from the sound collecting signal; and
an adaptive echo canceller which subtracts a pseudo echo signal, which is obtained by processing the input signal by an adaptive filter, from the corrected sound collecting signal produced by the post processor.

2. The video conference device according to claim 1, wherein the sound collecting portion has a microphone array in which a plurality of microphones are aligned;
wherein the sound collection signal processing portion includes:
a sound-collection beam producing portion for producing a plurality of sound collecting beam signals having a sound collecting directivity in a plurality of directions, by applying a delay processing to the sound signal picked up by the plurality of microphones and synthesizing delayed sound signals; and
a signal selecting portion for sensing a talker's direction based on levels of sound volumes of the plurality of sound collecting beam signals, and outputting a sound collecting beam signal in the talker's direction as the sound collecting signal;
wherein the filter coefficient setting portion sets the filter coefficient, which corresponds to the sound collecting beam signal that the signal selecting portion selects, out of a plurality of filter coefficients which correspond to the sound collecting directivities of the plurality of sound collecting beam signals produced by the sound-collection beam producing portion to the fixed filter, as the pseudo filter coefficient.

3. The video conference device according to claim 1, further comprising:
a band-pass filter provided at a preceding stage of the fixed filter to allow only a predetermined frequency band of the input signal to pass through.

4. The video conference device according to claim 3, wherein the band-pass filter is a low-pass filter whose pass band is below 1 kHz.

5. The video conference device according to claim 2, wherein the image picking-up portion changes a shooting condition, based on the talker's direction sensed by the signal selecting portion.

6. The video conference device according to claim 2, wherein the signal selecting portion further includes a band pass filter that allows a main component band of a human voice to pass through, and senses the talker's direction based on the signal levels of the plurality of sound collecting beam signals subjected to a band-pass filtering process by the band pass filter.
